(19) United States
(12) Patent Application Publication
(10) Pub. No.: US 2026/0188770 A1
(43) Pub. Date: Jul. 2, 2026

(54) BATTERY SYSTEM WITH IMPROVED BUSBAR AND CIRCUIT BOARD CONNECTION

(71) Applicant: Wisk Aero LLC, Mountain View, CA (US)

(72) Inventors: Anuj Chopra, Santa Clara, CA (US); Jacob Ryser, Mesa, AZ (US); Sytse Tacoma, Christchurch (NZ)

(73) Assignee: Wisk Aero LLC, Mountain View, CA (US)

(21) Appl. No.: 19/435,415

(22) Filed: Dec. 29, 2025

Related U.S. Application Data
(60) Provisional application No. 63/772,411, filed on Mar. 14, 2025.
(60) Provisional application No. 63/740,110, filed on Dec. 30, 2024.

(51) Int. Cl. H01M 10/48; H01M 50/204; H01M 50/507

(52) U.S. Cl. CPC H01M 10/482; H01M 10/486; H01M 50/204; H01M 50/507

(57) ABSTRACT

A battery module may include a circuit board including an electrical measurement circuitry configured to measure electrical characteristics of a battery electrically coupled to the circuit board, a plurality of busbars electrically coupled to the circuit board, and a plurality of battery cells electrically coupled to the circuit board through the plurality of busbars. A first battery cell of the plurality of battery cells may include a first terminal electrically coupled to a first busbar of the plurality of busbars and a second terminal electrically coupled to a second busbar of the plurality of busbars.

### CROSS-REFERENCES TO RELATED APPLICATIONS

This application claims priority to Provisional Patent Application No. 63/740,110, for “Battery System with Improved Busbar And Circuit Board Connection,” filed on December 30, 2024, and Provisional Patent Application No. 63/772,411, for “Battery System With Improved Busbar And Circuit Board Connection,” filed on March 14, 2025, each of which is incorporated herein by reference in its entirety for all purposes.

### BACKGROUND

The development of electronics has placed an increasingly large importance on the capabilities of battery systems. For example, battery systems used in electric vehicles are designed to provide power to the various components in electric vehicles. However, there are challenges in designing battery systems to optimally provide power to those components.

### SUMMARY

A battery module including battery cells electrically coupled to a circuit board through busbars. The circuit board may include an electrical measurement circuitry, such as a voltage sensing mechanism. The busbar can be coupled to the circuit board with pins that allow for the current to flow from the battery cells, through the busbars and the pins, to the circuit board. In this manner, the electrical measurement circuitry can be electrically coupled to the battery cells to track and manage the health and power output of the battery cells while having less weight than other conventional battery modules.

One aspect of the disclosure provides for a battery module that may include a circuit board including an electrical measurement circuitry configured to measure electrical characteristics of a battery electrically coupled to the circuit board, a plurality of busbars electrically coupled to the circuit board, and a plurality of battery cells electrically coupled to the circuit board through the plurality of busbars. A first battery cell of the plurality of battery cells may include a first terminal electrically coupled to a first busbar of the plurality of busbars and a second terminal electrically coupled to a second busbar of the plurality of busbars.

Implementations may include one or more of the following features. The first busbar may be positioned between the circuit board and at least a portion of the first terminal. The first terminal may be received through a first aperture defined by the first busbar. The first terminal may be folded over an end of the first busbar. The battery module may further include a plurality of pins, where each busbar of the plurality of busbars may be coupled to the circuit board through a respective pin of the plurality of pins and each battery cell of the plurality of battery cells may be electrically coupled to the circuit board through a corresponding busbar of the plurality of busbars and a corresponding pin of the plurality of pins coupling the corresponding busbar to the circuit board. Each pin of the plurality of pins may be in contact with a wire in the circuit board electrically coupled to the electrical measurement circuitry. The electrical measurement circuitry may be configured to measure one or more of a voltage, current, temperature, state of charge, state of health, capacity of each battery cell of the plurality of battery cells. A second battery cell of the plurality of battery cells may include a third terminal electrically coupled to the first busbar and a fourth terminal electrically coupled to a third busbar of the plurality of busbars. The first busbar may be electrically isolated from the second busbar.

One aspect of the disclosure provides for a battery module that may include a circuit board including an electrical measurement circuitry configured to measure electrical characteristics of a battery electrically coupled to the circuit board, a plurality of busbars electrically coupled to the circuit board, a plurality of battery cells electrically coupled to the circuit board through the plurality of busbars, where a first battery cell of the plurality of battery cells may include a positive terminal electrically coupled to a first busbar of the plurality of busbars and a negative terminal electrically coupled to a second busbar of the plurality of busbars.

Implementations may include one or more of the following features. The first busbar may be positioned between the circuit board and at least a portion of the positive terminal. The positive terminal may be received through a first aperture defined by the first busbar. The positive terminal may be folded over an end of the first busbar. The battery module may include a plurality of pins, where each busbar of the plurality of busbars may be coupled to the circuit board through a respective pin of the plurality of pins and each battery cell of the plurality of battery cells may be electrically coupled to the circuit board through a corresponding busbar of the plurality of busbars and a corresponding pin of the plurality of pins coupling the corresponding busbar to the circuit board. The electrical measurement circuitry may be configured to measure one or more of a voltage, current, temperature, state of charge, state of health, capacity of each battery cell of the plurality of battery cells. A second battery cell of the plurality of battery cells may include a second negative terminal electrically coupled to the first busbar and a second positive terminal electrically coupled to a third busbar of the plurality of busbars.

One aspect of the disclosure provides for a battery module may include a circuit board including an electrical measurement circuitry configured to measure electrical characteristics of a battery electrically coupled to the circuit board, a first busbar electrically coupled to the circuit board, a second busbar electrically coupled to the circuit board, a plurality of battery cells electrically coupled to the circuit board through the first busbar and the second busbar, where a first battery cell of the plurality of battery cells may include a first terminal electrically coupled to the first busbar and a second terminal electrically coupled to the second busbar.

Implementations may include one or more of the following features. The first terminal may be folded over an end of the first busbar. The battery module may include a plurality of pins, where the first busbar and the second busbar are coupled to the circuit board through a respective pin of the plurality of pins, and each battery cell of the plurality of battery cells may be electrically coupled to the circuit board through the first busbar or the second busbar and the respective pin. The electrical measurement circuitry may be configured to measure one or more of a voltage, current, temperature, state of charge, state of health, capacity of each battery cell of the plurality of battery cells.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, according to at least one example.

FIG. 1B illustrates an exploded, isometric view of the battery pack of FIG. 1A, according to at least one example.

FIG. 2A illustrates an isometric view of an example battery module, according to at least one example.

FIG. 2B illustrates an enlarged view of a portion of the battery pack of FIG. 2A, according to at least one example.

FIG. 3A illustrates a top, isometric view of an example busbar, according to at least one example.

FIG. 3B illustrates a bottom, isometric view of the busbar of FIG. 3A, according to at least one example.

FIG. 4 illustrates a top, isometric view of an example secondary busbar, according to at least one example.

FIG. 5 illustrates a top, isometric view of an example circuit board, according to at least one example.

FIG. 6 illustrates a cross-sectional view of a portion of the battery pack of FIG. 1A, according to at least one example.

FIG. 7 illustrates an example diagram of some of the electrical connection between the busbars and the battery cells of the battery pack of FIG. 1A, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Large electronic systems (e.g., electric vehicles or the like) may require power from multiple batteries coupled together. It may be beneficial to track and manage the health and power output of the batteries. For example, it can be helpful to know the voltage of a battery so that an appropriate voltage can be used to charge the battery. Using a voltage that is lower than the voltage of the battery will not fully charge the battery, while using a voltage that is significantly higher than the voltage of the battery can damage the battery. There are challenges in monitoring the voltage levels of batteries in such large electronic systems.

One solution may include providing a large sheet of metal to act as a current collector that is electrically coupled between the batteries and a voltage sensing mechanism in a battery module. However, in order for the voltage sensing mechanism to measure the voltage of the batteries in this example, the batteries are electrically coupled to the voltage sensing mechanism using a heavier electrical connection system (e.g., ultrasonic wire bonding or the like). While this increased weight may be acceptable for certain types of electric vehicles (e.g., electric automotive vehicles), such increased weight may lead to decreased performance for other types of electric vehicles (e.g., electric aircraft).

Another solution may include electrically coupling batteries to a circuit board (e.g., a printed circuit board or the like) including voltage sensing mechanism (e.g., analog circuit, a microcontroller, or the like). For certain electric vehicles that do not require as much power (and, therefore, as many batteries), such as automotive vehicles, the batteries may be directly coupled to the circuit board as the total ampacity outputted by the batteries in those electric vehicles may be less than the ampacity capacity of the circuit board. For example, the batteries of automotive vehicles may output about 20 A while the amount of conductive material (e.g., copper or the like) in the circuit board may provide an ampacity capacity of about 50 A.

However, such a direct connection may not work with other electric vehicles that requires more power and batteries, such as for electric aircraft. For example, electric aircraft can require enough batteries to provide a total ampacity of greater than about 150 A, greater than about 200 A, or the like. Such a total ampacity can be significantly higher than the ampacity capacity of a circuit board. Accordingly, batteries in an electric aircraft may not be able to directly couple with a circuit board.

The present disclosure provides a battery module including battery cells electrically coupled to a circuit board through busbars. The circuit board may include an electrical measurement circuitry, such as a voltage sensing mechanism or the like. The busbar can be coupled to the circuit board with pins that allow for the current to flow from the battery cells, through the busbars and the pins, to the circuit board. The busbars can provide sufficient electrical resistance to the current from the battery cells such that the remaining current to the circuit board is reduced to be within the ampacity capacity that can be handled by the circuit board. In this manner, the circuit board can be electrically coupled to the battery cells to track and manage the health and power output of the battery cells while having less weight than other conventional battery modules.

Example busbars can include sidewalls that extend from a busbar body at a transverse angle (e.g., at an orthogonal angle, non-orthogonal angle, or the like) such that the busbar can define a cross-sectional bracket shape. The busbar may include a thickness that can provide sufficient electrical resistance to the current from the battery cells coupled to the busbar such that, when the busbar is assembled with all the other busbars and battery cells to the circuit board, the total ampacity from the battery cells may be reduced to the ampacity capacity of the circuit board. The busbar can define busbar slots sized and shaped to receive corresponding terminals of battery cells. The busbar slots can be defined along a body of the busbar and, in some embodiments, along a portion of the busbar sidewalls. In some embodiments, the busbar can have four busbar slots. However, in other embodiments, the busbar can have more or less busbar slots. Each of the busbar slots may be spaced from an adjacent busbar slot and ends of the busbar with enough distance that, after a corresponding terminal is folded onto the busbar body, the portions of the terminals folded onto the busbar body are spaced from adjacent terminals.

In some embodiments, the busbar may not include sidewalls. Instead, the busbar can define slots to receive a portion of a corresponding terminal without busbar sidewalls. The slots may be distanced from each other such that the portion of the terminals received in the slots and folded over onto the busbar body will not touch each other. This busbar can still have a thickness that can provide sufficient electrical resistance to the current from the battery cells coupled to the busbar such that, when the busbar is assembled with all the other busbars and battery cells to the circuit board, the total ampacity from the battery cells may be reduced to the ampacity capacity of the circuit board.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, heavy machinery, transportation equipment, aeronautical and/or spacecraft electronics payloads, vehicles, as well as any other device that may use battery cells or benefit from the discussed designs. Accordingly, the disclosure and claims are not to be considered limited to any particular example discussed but can be utilized broadly with any number of devices that may exhibit some or all of the electrical or chemical characteristics of the discussed examples.

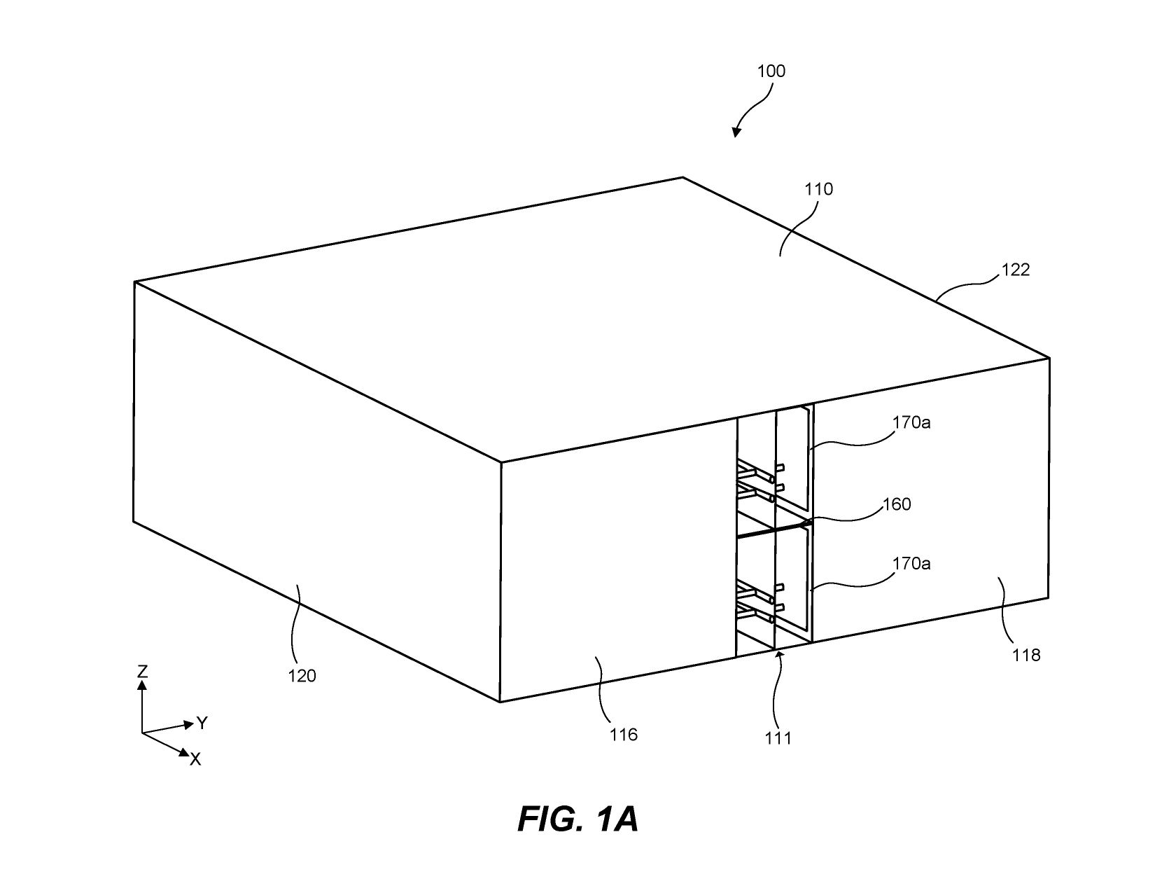

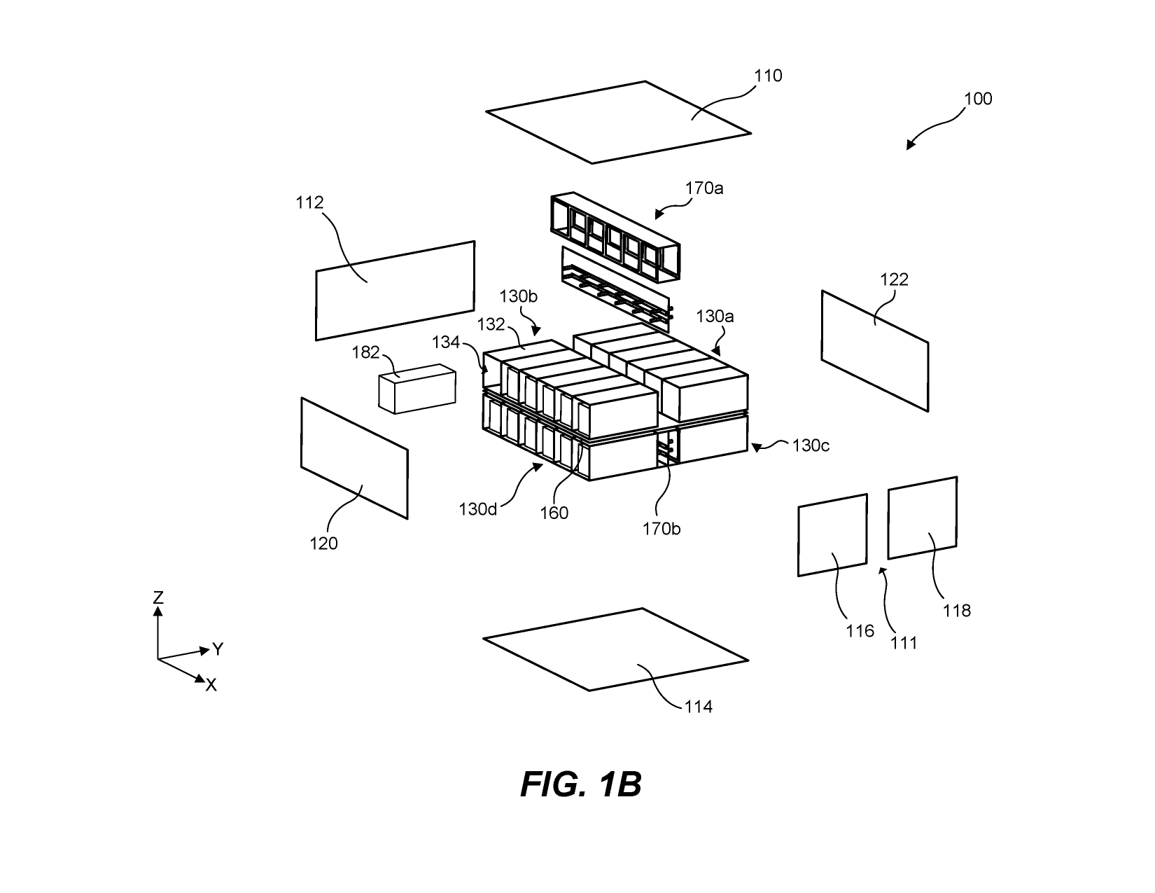

FIGS. 1A and 1B depict an example battery pack 100. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells such that each module row 130a, 130b, 130c, 130d. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

The battery pack 100 may include a platform 160 on which the battery modules 132 and venting systems 170a, 170b are positioned on. In particular, the battery modules 132 of the module rows 130a, 130b and the first venting system 170a may be on a top surface of the platform 160, and the battery modules 132 of the module rows 130a, 130b and the second venting system 170b may be positioned on a bottom surface of the platform 160. In some embodiments, the battery modules 132 and venting systems 170a, 170b may be coupled against the platform 160 (e.g., via welding, brazing, soldering, gluing, fastening, or the like).

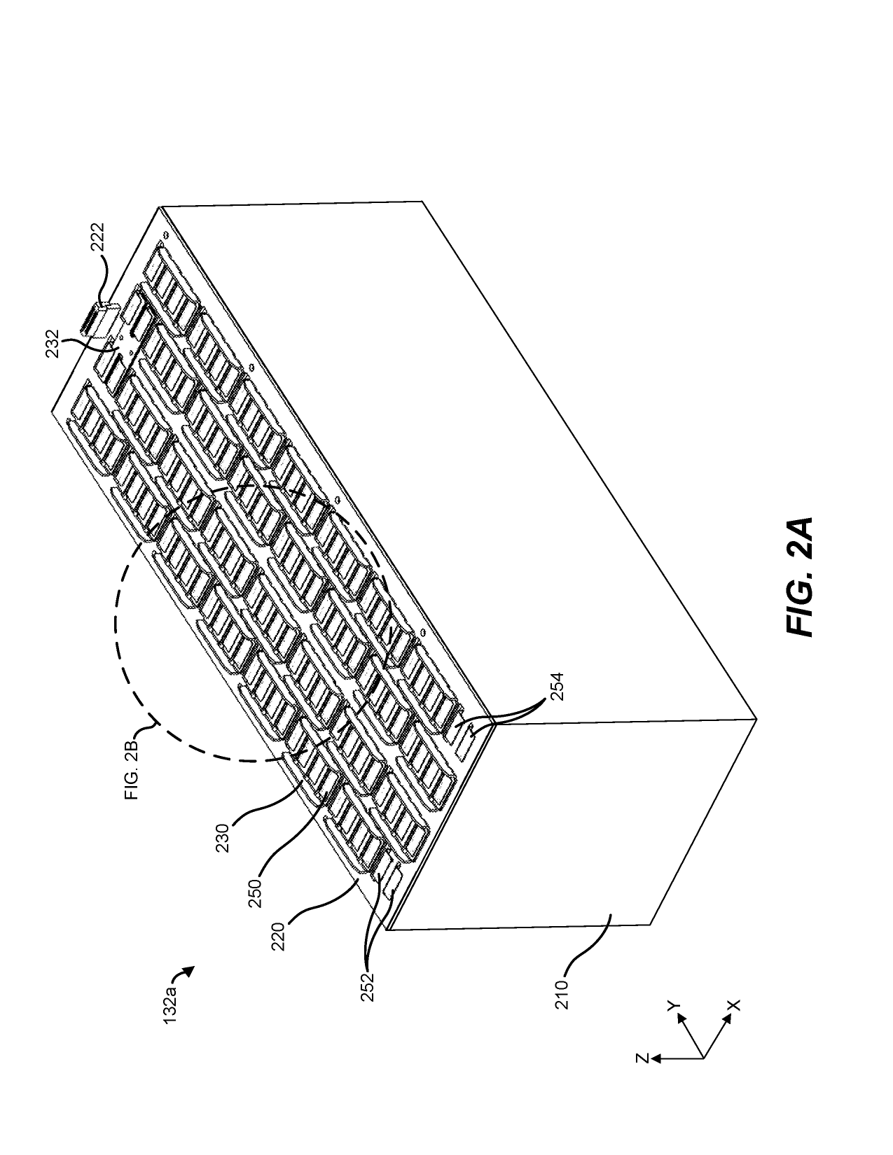

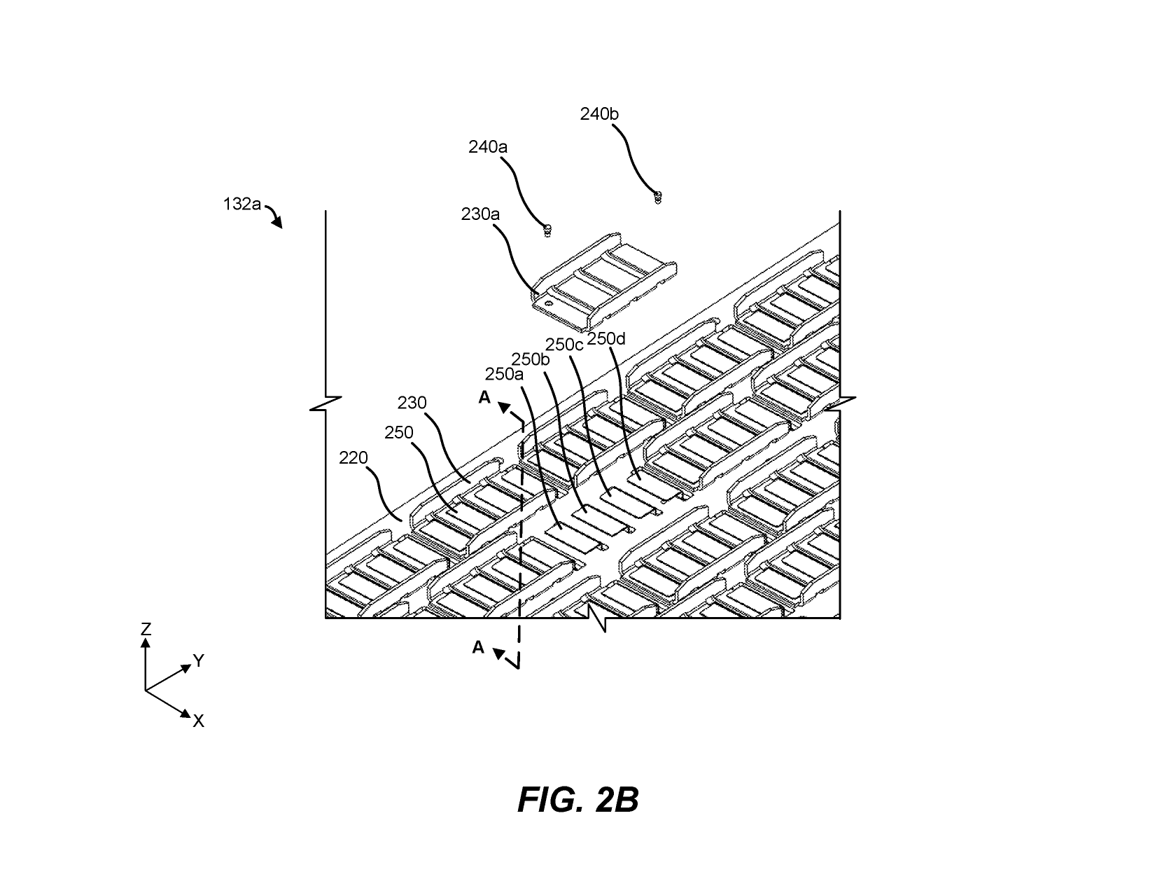

FIG. 2A depicts a first battery module 132a of the battery pack 100. FIG. 2B depicts an enlarged, partially-exploded view of a portion of the first battery module 132a. In some embodiments, all the battery modules 132 of the battery pack 100 may include a similar structure as the first battery module 132a. However, in other embodiments, one or more of the other battery modules may have a different structure than the first battery module. It should be understood that, for the sake of visual clarity, the first battery module 132a may include additional components not depicted in FIGS. 2A and 2B.

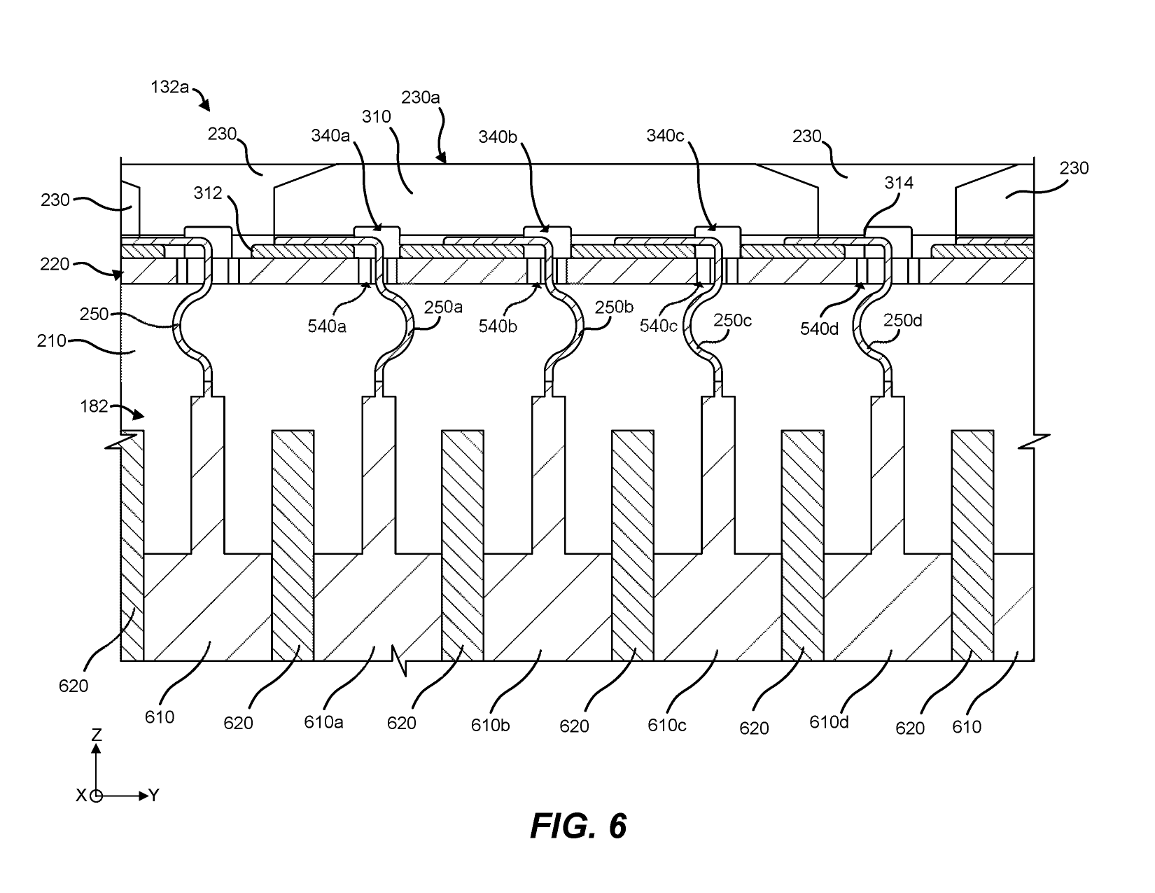

The first battery module 132a may include a housing 210 and a circuit board 220 coupled to the housing 210 (e.g., via welding, brazing, soldering, gluing, fastening, or the like). The housing 210 may house a grouping 182 of battery cells (e.g., battery cells 610, as shown in FIG. 6). The first battery module 132a may include busbars 230 coupled to the circuit board 220. The circuit board 220 may include an electrical measurement circuitry 222 that can measure electrical characteristics of a battery cell housed in the housing 210 (e.g., voltage, current, temperature, state of charge, state of health, capacity, or the like). Terminals 250 of the battery cells may extend through the circuit board 220 to couple with busbars 230. As the busbars 230 and terminals 250 may include and/or be made of a conductive material (e.g., silver, copper, gold, aluminum, brass, bronze, graphite, conductive polymers or the like), the battery cells may be electrically coupled with the electrical measurement circuitry 222 of the circuit board 220 through the busbars 230.

As noted above, conventional battery modules may be unable to couple battery cells to a circuit board without adding excessive weight or due to the ampacity limitations of the circuit board. The first battery module 132a of the present disclosure addresses these issues by electrically coupling the battery cells to the circuit board 220 through the busbars 230. The busbars 230 can provide sufficient electrical resistance to the current from the battery cells such that the remaining current to the circuit board 220 is reduced to be within the ampacity capacity that can be handled by the circuit board 220. Accordingly, each busbar 230 may include a sufficient thickness along the X-Z plane to provide an electrical resistance that, when assembled with all the other busbars 230 and battery cells to the circuit board 220, can reduce the current from the battery cells to a total ampacity equal to or less than the ampacity capacity of the circuit board 220. In this manner, the electrical measurement circuitry 222 can measure the electrical characteristics of the battery cells through the busbars 230 while having less weight than conventional battery packs (e.g., due to the busbars 230 having less weight than a single sheet current collector, as in conventional battery modules) and without being limited by the ampacity of the circuit board 220.

Turning to FIG. 2B, the first battery module 132a is depicted as being partially-exploded with a first busbar 230a vertically spaced from the circuit board 220 for ease of description. In some embodiments, all the busbars 230 of the battery pack 100 may include a similar structure, and may be similarly coupled to the circuit board 220, as the first busbar 230a. However, in other embodiments, one or more of the other busbars may have a different structure than the first busbar.

As will be discussed further below, the first busbar 132a may couple with certain terminals 250 of battery cells housed in the housing 210. For example, the first busbar 230a may couple with a first terminal 250a, a second terminal 250b, a third terminal 250c, and a fourth terminal 250d. Each terminal 250a, 250b, 250c, 250d may extend from a different battery cell. However, in other embodiments, two or more of the terminals can extend from a same battery cell.

The first busbar 230a may couple to the circuit board 220 through a first securement component 240a and a second securement component 240b. In particular, when assembled, the securement components 240a, 240b may extend through different portions of the first busbar 230a and at least partially through the circuit board 220 (e.g., partially through the circuit board 220, entirely through the circuit board 220, or the like) such that the securement components 240a, 240b contact the wires that are positioned in the circuit board 220 (e.g., a trace or the like) and that are connected to the electrical measurement circuitry 222. The securement components 240a, 240b may include and/or be made of a conductive material (e.g., silver, copper, gold, aluminum, brass, bronze, graphite, conductive polymers, or the like). In this manner, the terminals 250a, 250b, 250c, 250d can conduct electricity from the battery cells, through the first busbar 230a, the securement components 240a, 240b, the wires in the circuit board 220, and to the electrical measurement circuitry 222 so that the electrical measurement circuitry 222 can measure the electrical characteristics of the battery cells housed in the housing 210.

The securement components 240a, 240b may be press-fitted into the first busbar 230a and the circuit board 220, and later soldered. In some embodiments, the securement components 240a, 240b may be a pin. However, in other embodiments, one or more of the securement components may be other structures that can couple the first busbar to the circuit board and to contact the wires in the circuit board. For example, the securement components may be a screw, a liquid metal, or the like.

Turning back to FIG. 2A, not all the terminals 250 extending through the circuit board 220 may couple with a busbar 230. For example, a first set 252 of terminals 250 may not be coupled to a busbar 230 and, instead, may be coupled to a first electronic component (not shown). Additionally, a second set 254 of terminals 250 may not be coupled to a busbar 230 and, instead, may be coupled to a second electronic component (not shown). However, in other embodiments, the terminals of the first set may also be coupled to a busbar (e.g., a busbar having a shorter length than the busbars shown in FIG. 2A to accommodate two terminals 250 rather than four).

While some busbars 230 include a similar shape to each other, other busbars 230 may not. For example, a secondary busbar 232 may have a different shape than the other busbars 230. Specifically, the secondary busbar 232 may have a planar shape rather than a bracket shape of the other busbars 230. However, in some embodiments, each of the busbars may have a similar shape. The secondary busbar 232 and the electronic components coupled over the sets 252, 254 of terminals 250 may be coupled to the circuit board 220 through corresponding securement components 240a, 240b similar to the securement components 240a, 240b coupling the busbars 230 to the circuit board 220. Each busbar 230, 232 may be distanced from adjacent busbars 230, 232 such that each busbar 230, 232 is spaced and electrically isolated from adjacent busbars 230 to minimize the risk of causing a short circuit (e.g., from the busbars 230 touching while the battery cells 610 are providing power).

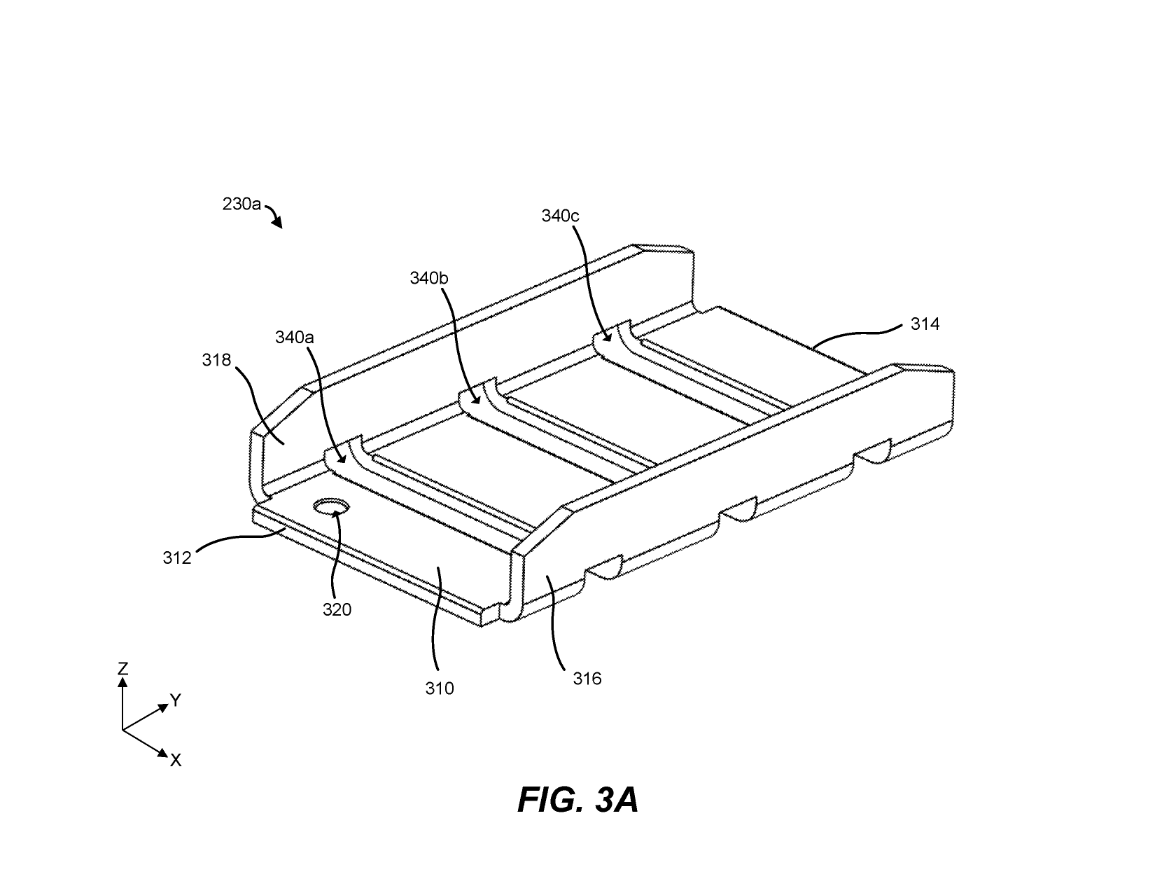

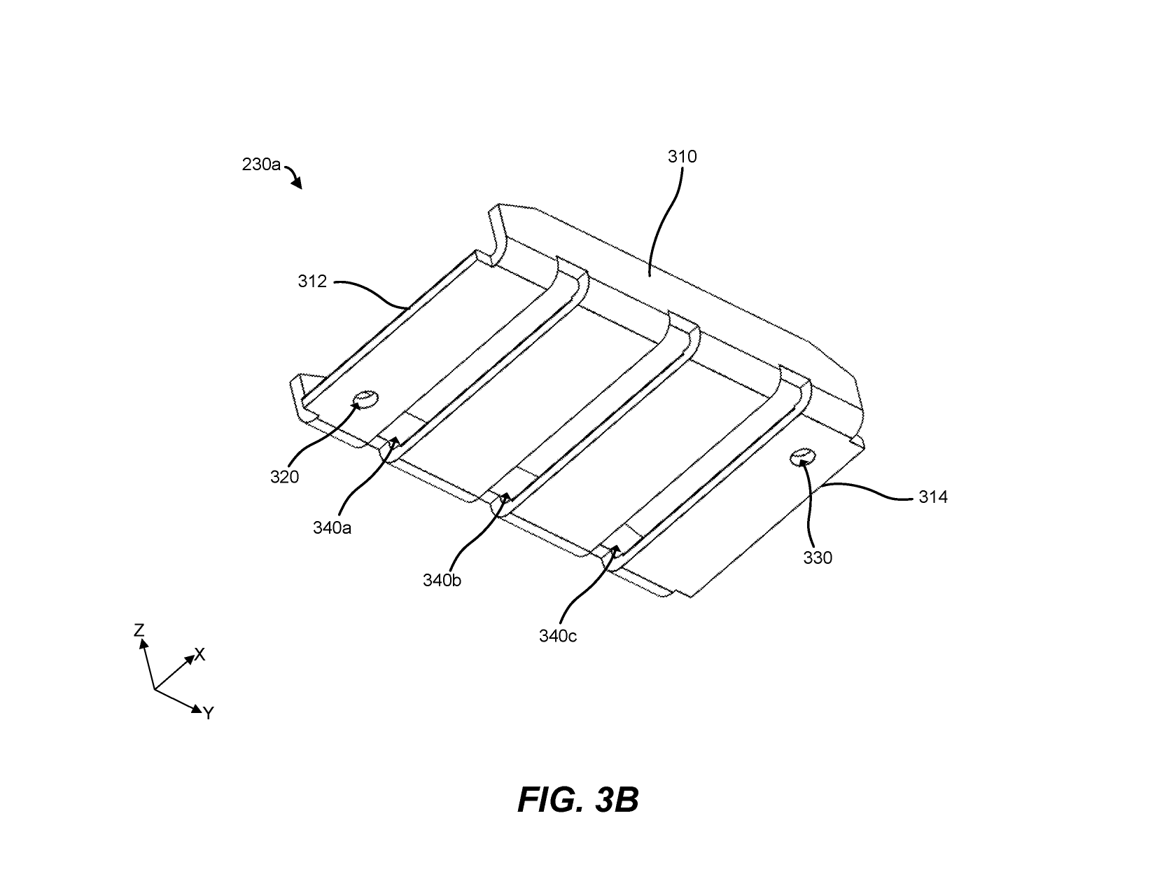

FIGS. 3A and 3B depict isometric views of the first busbar 230a. The first busbar 230a may include a busbar body 310 with a first busbar sidewall 316 and a second busbar sidewall 318 extending from lateral edges of the busbar body 310. The busbar sidewalls 316, 318 may extend from the busbar body 310 along a Z-axis, however, in other embodiments, the one or more of the busbar sidewalls may extend from the busbar body 310 at a non-perpendicular angle form the busbar body 310. Accordingly, the first busbar 230a may define a cross-sectional bracket shape along an X-Z plane. As noted above, the first busbar 230a may include a cross-sectional thickness along the X-Z plane that can provide sufficient electrical resistance to the current from the battery cells coupled to the first busbar 230a such that, when the first busbar 230a is assembled with the other busbars 230, battery cells corresponding to the terminals 250, and the circuit board 220, the total ampacity from the battery cells may be reduced to the ampacity capacity of the circuit board 220. For example, the first busbar 230a may include a thickness of between about 0.2 mm and 2.2 mm, such as between about 0.4 mm and 2 mm, such as between about 0.6 mm and 1.8 mm, such as between about 0.8 mm and 1.6 mm, such as between about 1 mm and 1.4 mm, or the like.

The first busbar 230a may include busbar sidewalls 316, 318 to define the cross-sectional bracket shape so that, when assembled with all the busbars 230 on the circuit board 220, all the busbars 230 may fit onto the circuit board 220 with sufficient space between each of the busbars 230 to minimize the risk of adjacent busbars 230 contacting and causing a short. Accordingly, the busbar sidewalls 316, 318 may extend from the busbar body 310 along the Z-axis with a height of between about 2 mm and 10 mm, such as between about 4 mm and 8 mm, or about 6 mm. In contrast, in other embodiments, where more (or all) of the busbars are formed such that the busbar sidewalls do not include as large of a height as shown in FIGS. 3A and 3B (or where the busbars do not include busbar sidewalls at all), the busbars may exceed the spatial constraints of the circuit board (e.g., along the X-Y plane). However, in other embodiments, the first busbar may be substantially planar such that the busbar body does not include side walls (e.g., similar to the secondary busbar 232).

The busbar body 310 may define a first busbar aperture 320 adjacent a first end 312 of the busbar body 310 and a second busbar aperture 330 adjacent a second end 314 of the busbar body 310. The first busbar aperture 320 may be sized and shaped to receive the first securement component 240a and the second busbar aperture 330 may be sized and shaped to receive the second securement component 240b. Each of the busbar apertures 320, 330 may be closer to one side of the busbar body 310 than the other (e.g., along an X-axis). However, in other embodiments the busbar apertures may be centrally positioned along a width of the busbar body. Each of the busbar apertures 320, 330 may be longitudinally offset from each other along a Y-axis. However, in other embodiments, the busbar apertures may be longitudinally aligned with each other (e.g., along a Y-axis).

The first busbar 230a may define busbar slots sized and shaped to receive certain corresponding terminals 250a, 250b, 250c. For example, the busbar body 310 and a portion of the busbar sidewalls 316, 318 (e.g., the portion of the busbar sidewalls 316, 318 adjacent the busbar body 310) may define a first busbar slot 340a to receive the first terminal 250a, a second busbar slot 340b to receive the second terminal 250b, and a third busbar slot 340c to receive the third terminal 250c. Defining the busbar slots 340a, 340b, 340c along a portion of the busbar sidewalls 316, 318 may be beneficial to minimize the risk of defects when manufacturing the first busbar 230a. For example, the first busbar 230a may be manufactured by cutting the busbar slots 340a, 340b, 340c into a sheet metal and then folding that sheet metal to form the first busbar 230a with the bracket shape. However, in other embodiments, the busbar slots may be cut into the sheet metal such that, when the sheet metal is folded to define the busbar body and busbar sidewalls, the ends of the busbar slots coincide with the corners where the busbar body and busbar sidewalls meet rather than extending along a portion of the busbar sidewalls (e.g., as shown with the busbar slots 340a, 340b, 340c in FIGS. 3A and 3B). In this example, there may be an increased risk of tearing when folding the sheet metal, such as an increased risk of tearing at the meeting point between the busbar slots, busbar sidewall, and busbar body. The first busbar 230a solves this issue by defining the busbar slots 340a, 340b, 340c to have a width extending along the X-axis such that, when the sheet metal is folded to form the first busbar 230a, the busbar slots 340a, 340b, 340c may extend along a portion of the busbar sidewalls 316, 318. However, in other embodiments, the busbar slots may be defined by only the busbar body and may not extend to the busbar sidewalls. Each of the busbar slots 340a, 34b, 340c may be sized and shaped to receive a corresponding terminal 250 of a battery cell housed in the housing 210.

Although the first busbar 230a is configured to couple with four terminals 250a, 250b, 250c, 250d, the first busbar 230a may define three busbar slots 340a, 34b, 340c (e.g., less busbar slots 340a, 34b, 340c than terminals 250a, 250b, 250c, 250d intended to be assembled onto the first busbar 230a). As will be discussed further below, the fourth terminal 250d may be folded over the second end 314 to couple with the busbar body 310. Folding the fourth terminal 250d over the second end 314 in this manner may be beneficial to minimize a length and weight of the busbar body 310 needed to couple terminals 250a, 250b, 250c, 250d to the busbar body 310. However, in other embodiments, the busbar body 310 may define more or less than three busbar slots, such as two busbar slots, four busbar slots, five busbar slots, or the like.

Each of the busbar slots 340a, 34b, 340c may be spaced from an adjacent busbar slot 340a, 34b, 340c and ends 312, 314 with enough distance that, after a corresponding terminal 250a, 250b, 250c, 250d is folded onto the busbar body 310 (e.g., after the terminals 250a, 250b, 250c, 250d are received through the corresponding busbar slot 340a, 34b, 340c and over the second end 314), the portions of the terminals 250a, 250b, 250c, 250d folded onto the busbar body 310 are spaced from adjacent terminals 250a, 250b, 250c, 250d (e.g., as shown in FIG. 2A). For example, the first busbar 230a may define a distance between busbar slots 340a, 34b, 340c and ends 312, 314 to be between about 5 mm and 25 mm, between about 10 mm and 20 mm, or about 15 mm. In this manner, the risk that adjacent terminals 250a, 250b, 250c, 250d may contact each other and cause a short circuit may be minimized. In some embodiments, the busbar slots 340a, 34b, 340c and ends 312, 314 may be equally spaced from each other, however, in other embodiments, one or more of the busbar slots and ends may not be equally spaced from adjacent busbar slots and ends.

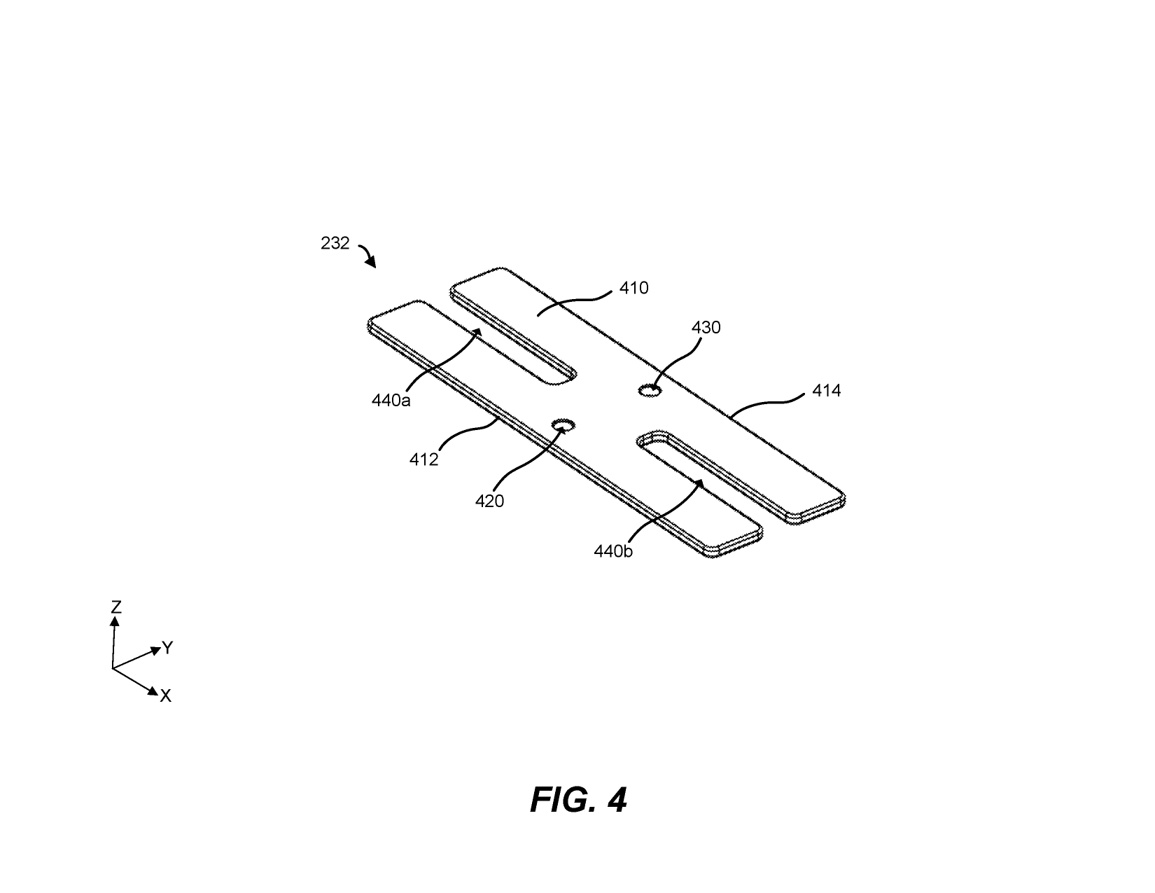

FIG. 4 depicts the secondary busbar 232. The second busbar 232 may include a secondary busbar body 410 defining a first secondary slot 440a and a second secondary slot 440b that are each sized and shaped to receive a corresponding terminal 250, similar to the busbar slots 340a, 340b, 340c. Each of the secondary slots 440a, 440b may include similar dimensions, however, in other embodiments, one of the secondary slots may not include similar dimensions as the other. The secondary busbar body 410 may also define a first secondary aperture 420 adjacent a first secondary end 412 and a second secondary aperture 430 adjacent a second secondary end 414. Although the secondary apertures 420, 430 are depicted as being aligned along the Y-axis, in other embodiments, the secondary apertures may not be aligned along the Y-axis and, instead, may be offset. The secondary apertures 420, 430 may be sized and shaped to receive a corresponding securement component 240a, 240b. The secondary busbar body 410 may define a distance between the secondary slots 440a, 440b and secondary ends 412, 414 such that a portion of a terminal 250 may be received in the secondary slots 440a, 440b, and for a portion of a terminal 250 to be received over the second secondary end 414 and folded onto the secondary busbar body 410, without the terminals 250 touching each other. Although FIG. 4 depicts this distance between the secondary slots 440a, 440b and secondary ends 412, 414 as being similar, in other embodiments, this distance may not be similar. As noted above, the secondary busbar 232 may have a thickness along the X-Z plane that can provide a sufficient resistance to the battery cells coupled to the secondary busbar 232 that, when assembled with the other busbars 230, battery cells coupled to those busbars 230, and the circuit board 220, the ampacity of all the battery cells can be reduced by the busbars 230, 232 to be within the ampacity capacity of the circuit board 220.

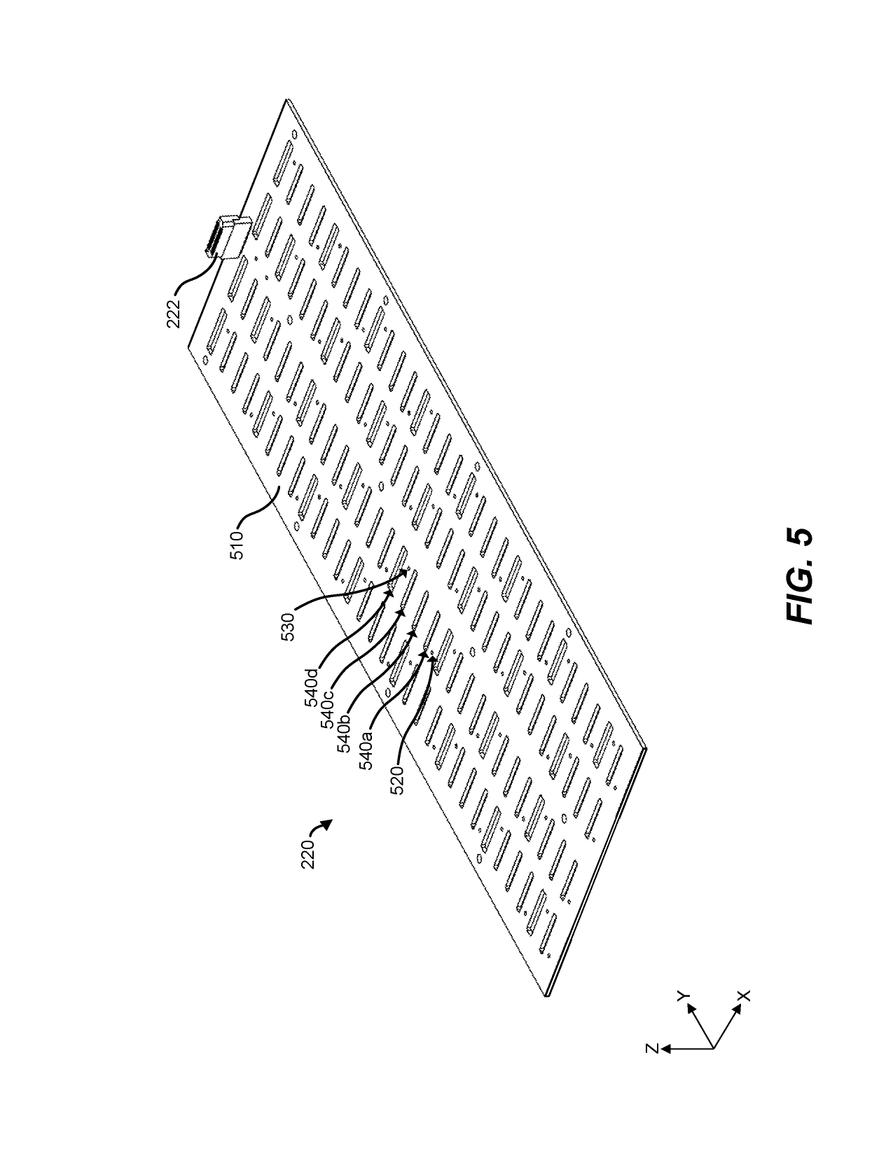

FIG. 5 depicts an isometric view of the circuit board 220. The circuit board 220 may include a board body 510 defining board slots sized and shaped to receive terminals 250a, 250b, 250c, 250d, and board apertures sized and shaped to receive the securement components 240a, 240b. For example, the board body 510 may define a first board slot 540a to receive the first terminal 250a, a second board slot 540b to receive the second terminal 250b, a third board slot 540c to receive the third terminal 250c, and a fourth board slot 540d to receive the fourth terminal 250d. The board body 510 may also define a first board aperture 520 to receive the first securement component 240a and a second board aperture 530 to receive the second securement component 240b.

The board body 510 may define sets of board slots 540a, 540b, 540c, 540d and board apertures 520, 530 for each busbar 230, 232 coupled to the circuit board 220. For example, the board slots 540a, 540b, 540c, 540d and board apertures 520, 530 corresponding to the first busbar 230a may be a first set specific to the first busbar 230a as, when the first busbar 230a is coupled to the circuit board 220, the busbar slot 340a, 340b, 340c may align with the board slots 540a, 540b, 540c and the busbar apertures 320, 330 may align with the board apertures 520, 530. Accordingly, during assembly, the first terminal 250a may extend through the first board slot 540a and the first busbar slot 340a before being folded over onto the busbar body 310, the second terminal 250b may extend through the second board slot 540b and the second busbar slot 340b before being folded over onto the busbar body 310, and the third terminal 250c may extend through the third board slot 540c and the third busbar slot 340c before being folded over onto the busbar body 310. The fourth terminal 250d may extend through the fourth board slot 540d before being folded over the second end 314 onto the busbar body 310. The board body 510 may define a corresponding set of board slots 540a, 540b, 540c, 540d and board apertures 520, 530 for each of the busbars 230, 232 coupled to the circuit board 220. The board body 510 may also define corresponding board slots 540a, 540b, 540c, 540d for the sets 252, 254 of terminals 250.

FIG. 6 depicts a cross-sectional view of the first battery module 132a along Section A-A, as shown in FIG. 2B. In particular, the housing 210 of the first battery module 132a houses battery cells 610 with spacers 620 positioned between adjacent battery cells 610. With specific reference to the battery cells 610 coupled to the first busbar 230a, a portion of the first terminal 250a of a first battery cell 610a may extend through the first board slot 540a and the first busbar slot 340a to fold over onto the busbar body 310, a portion of the second terminal 250b of a second battery cell 610b may extend through the second board slot 540b and the second busbar slot 340b to fold over onto the busbar body 310, a portion of the third terminal 250c of a third battery cell 610c may extend through the third board slot 540c and the third busbar slot 340c to fold over onto the busbar body 310, and a portion of the fourth terminal 250d of a fourth battery cell 610d may extend through the fourth board slot 540d to fold over onto the busbar body 310. Each terminal 250a, 250b, 250c, 250d may be coupled with the busbar body 310 through welding, soldering, adhesive, or the like. In this manner, the battery cells 610a, 610b, 610c, 610d may be electrically connected with the first busbar 230a.

The other busbars 230 may similarly couple with the other battery cells 610 to the circuit board 220. Additionally, the secondary busbar 232, and electronic components coupled over the sets 252, 254 of terminals 250, may also similarly couple with corresponding battery cells 610. As each busbar 230, 232, and electronic components coupled over the sets 252, 254 of terminals 250, may be coupled to the circuit board 220 through corresponding securement components 240a, 240b, all the battery cells 610 housed in the housing 210 can be electrically coupled to the circuit board 220 such that the electrical measurement circuitry 222 can measure the electrical characteristics of each battery cell 610.

In some embodiments, as noted above, multiple battery terminals 250 may extend from each battery cell 610 such that each battery cell 610 may be electrically coupled to multiple busbars 230. For example, each pair of adjacent terminals 250 along an X-axis may extend from a battery cell housed in the housing 210. In this manner, each battery cell may be coupled to two busbars 230. As such, two rows of busbars 230 and terminals 250 that extend along a length of the first battery module 132a (e.g., along a Y-axis, as shown in FIG. 2A) may correspond with one row of battery cells 610. However, in other embodiments, only one terminal may extend from each battery cell such that each battery cell is coupled to one busbar. In yet other embodiments, the first battery module may have more or less than four rows of busbars and terminals (e.g., two, six, eight, or the like).

Each battery cell 610 may include a positive terminal 250 coupled to one busbar 230 and a negative terminal 250 coupled to another busbar 230. This configuration may be beneficial to allow for the battery cells 610 to be electrically coupled together in a combination of battery cells 610 coupled in series and battery cells 610 coupled in parallel. For example, in some embodiments, it may be beneficial for a majority of the battery cells 610 to be electrically coupled in series (e.g., the positive/negative terminals 250 of the battery cell 610 is electrically coupled to a terminal 250 of an adjacent battery cell 610 having an opposite charge) while a minority of battery cells 610 may be coupled in parallel (e.g., the positive/negative terminals 250 of the battery cell 610 is electrically coupled to a terminal 250 of an adjacent battery cell 610 having a same charge). Such a configuration may be beneficial to optimize the current and voltage for use.

In some examples, each row of battery cells 610 extending along a Y-axis in the housing 210 may include greater than about 50% of the battery cells 610 in series, greater than about 60%, greater than about 70%, greater than about 80%, greater than about 90%, or all of the battery cells 610. Additionally or alternatively, each row of battery cells 610 extending along a Y-axis in the housing 210 may include less than about 50% of the battery cells 610 in parallel, less than about 40% of the battery cells 610, less than about 30% of the battery cells 610, less than about 20% of the battery cells 610, less than about 10% of the battery cells 610, or the like. In one example, all of the battery cells 610 in a row may be coupled together in series (e.g., all of the battery cells 610 coupled together by the busbars 230) while only two of the battery cells 610 in that row may be coupled together in parallel (e.g., the battery cells 610 corresponding to the first set 252 or second set 254 of the terminals 250). However, in other embodiments, the battery cells may be electrically coupled together in any combination of series or parallel.

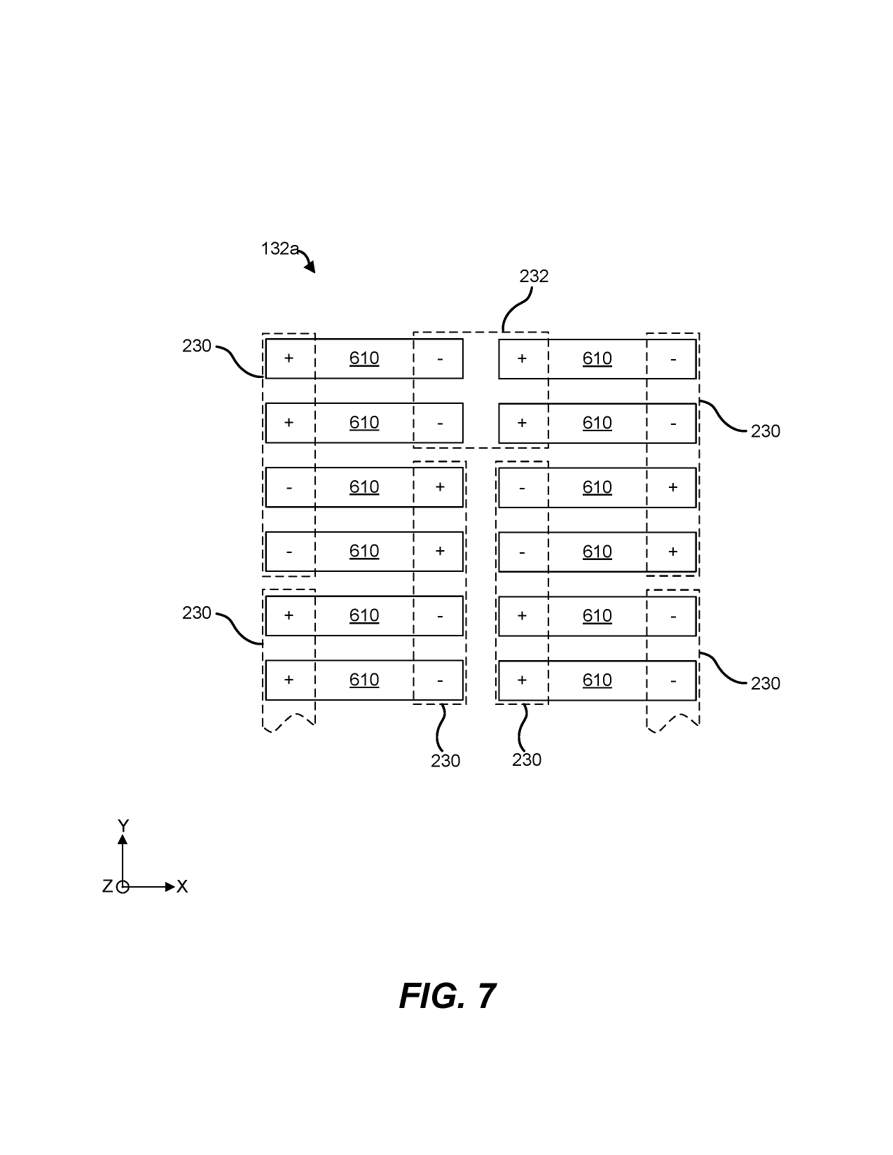

FIG. 7 depicts a schematic diagram of an example arrangement of battery cells 610 coupled to busbars 230, 232 (e.g., represented by the dashed-line boxes) for the twelve battery cells 610 closest to the electrical measurement circuitry 222. Each busbar 230, 232 can be coupled to a terminal 250 of underlying battery cells 610. Positive terminals 250 can be represented by a “+” symbol and negative terminals 250 can be represented by a “-” symbol. Although FIG. 7 does not depict all the battery cells 610 and busbars 230, 232 of the first battery module 132a, it is understood that the rest of the battery cells 610 and busbars 230 may include a similar arrangement.

As shown, the busbars 230, 232 may couple with multiple terminals 250 associated with different battery cells 610. In particular, the busbars 230, 232 may couple adjacent battery cells 610 in series such that each busbar 230, 232 couples with a combination of negative and positive terminals 250 of adjacent battery cells 610. Each busbar 230, 232 can couple with an equal number of positive and negative terminals 250, however, in other embodiments, one or more busbars may have a different amount of terminals of differing charges. However, in other embodiments, the busbars may electrically couple battery cells together in parallel (e.g., all terminals coupled to the busbar are the same charge).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail.

It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors

intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A battery module comprising:
a circuit board including an electrical measurement circuitry configured to measure electrical characteristics of a battery electrically coupled to the circuit board;
a plurality of busbars electrically coupled to the circuit board; and
a plurality of battery cells electrically coupled to the circuit board through the plurality of busbars, wherein a first battery cell of the plurality of battery cells includes a first terminal electrically coupled to a first busbar of the plurality of busbars and a second terminal electrically coupled to a second busbar of the plurality of busbars.

2. The battery module of claim 1, wherein the first busbar is positioned between the circuit board and at least a portion of the first terminal.

3. The battery module of claim 1, wherein the first terminal is received through a first aperture defined by the first busbar.

4. The battery module of claim 1, wherein the first terminal is folded over an end of the first busbar.

5. The battery module of claim 1, further comprising a plurality of pins, wherein:
each busbar of the plurality of busbars is coupled to the circuit board through a respective pin of the plurality of pins; and
each battery cell of the plurality of battery cells is electrically coupled to the circuit board through a corresponding busbar of the plurality of busbars and a corresponding pin of the plurality of pins coupling the corresponding busbar to the circuit board.

6. The battery module of claim 5, wherein each pin of the plurality of pins is in contact with a wire in the circuit board electrically coupled to the electrical measurement circuitry.

7. The battery module of claim 1, wherein the electrical measurement circuitry is configured to measure one or more of a voltage, current, temperature, state of charge, state of health, capacity of each battery cell of the plurality of battery cells.

8. The battery module of claim 1, wherein a second battery cell of the plurality of battery cells includes a third terminal electrically coupled to the first busbar and a fourth terminal electrically coupled to a third busbar of the plurality of busbars.

9. The battery module of claim 1, wherein the first busbar is electrically isolated from the second busbar.

10. A battery module comprising:
a circuit board including an electrical measurement circuitry configured to measure electrical characteristics of a battery electrically coupled to the circuit board;
a plurality of busbars electrically coupled to the circuit board; and
a plurality of battery cells electrically coupled to the circuit board through the plurality of busbars, wherein a first battery cell of the plurality of battery cells includes a positive terminal electrically coupled to a first busbar of the plurality of busbars and a negative terminal electrically coupled to a second busbar of the plurality of busbars.

11. The battery module of claim 10, wherein the first busbar is positioned between the circuit board and at least a portion of the positive terminal.

12. The battery module of claim 10, wherein the positive terminal is received through a first aperture defined by the first busbar.

13. The battery module of claim 10, wherein the positive terminal is folded over an end of the first busbar.

14. The battery module of claim 10, further comprising a plurality of pins, wherein:
each busbar of the plurality of busbars is coupled to the circuit board through a respective pin of the plurality of pins; and
each battery cell of the plurality of battery cells is electrically coupled to the circuit board through a corresponding busbar of the plurality of busbars and a corresponding pin of the plurality of pins coupling the corresponding busbar to the circuit board.

15. The battery module of claim 10, wherein the electrical measurement circuitry is configured to measure one or more of a voltage, current, temperature, state of charge, state of health, capacity of each battery cell of the plurality of battery cells.

16. The battery module of claim 10, wherein a second battery cell of the plurality of battery cells includes a second negative terminal electrically coupled to the first busbar and a second positive terminal electrically coupled to a third busbar of the plurality of busbars.

17. A battery module comprising:
a circuit board including an electrical measurement circuitry configured to measure electrical characteristics of a battery electrically coupled to the circuit board;
a first busbar electrically coupled to the circuit board;
a second busbar electrically coupled to the circuit board; and
a plurality of battery cells electrically coupled to the circuit board through the first busbar and the second busbar, wherein a first battery cell of the plurality of battery cells includes a first terminal electrically coupled to the first busbar and a second terminal electrically coupled to the second busbar.

18. The battery module of claim 17, wherein the first terminal is folded over an end of the first busbar.

19. The battery module of claim 17, further comprising a plurality of pins, wherein:
the first busbar and the second busbar are coupled to the circuit board through a respective pin of the plurality of pins; and
each battery cell of the plurality of battery cells is electrically coupled to the circuit board through the first busbar or the second busbar, and the respective pin.

20. The battery module of claim 17, wherein the electrical measurement circuitry is configured to measure one or more of a voltage, current, temperature, state of charge, state of health, capacity of each battery cell of the plurality of battery cells.
